(19) United States
(12) Patent Application Publication
(10) Pub. No.: US 2026/0179376 A1
(43) Pub. Date: Jun. 25, 2026

(54) MULTI-MODAL-FUSED METHOD AND APPARATUS FOR RECOGNIZING HIGH-DEFINITION MAP ELEMENT, AND DEVICE AND MEDIUM

(71) Applicant: Beijing Baidu Netcom Science Technology Co., Ltd., Beijing (CN)

(72) Inventors: Junjie Cai, Beijing (CN); Jianzhong Yang, Beijing (CN); Deguo Xia, Beijing (CN); Kai Zhong, Beijing (CN); Tongbin Zhang, Beijing (CN); Zhen Lu, Beijing (CN); Jizhou Huang, Beijing (CN)

(73) Assignee: Beijing Baidu Netcom Science Technology Co., Ltd., Beijing (CN)

(21) Appl. No.: 19/126,124

(22) PCT Filed: Oct. 12, 2023
(86) PCT No.: PCT/CN2023/124320

§ 371 Date: Jul. 21, 2025

(30) Foreign Application Priority Data
Nov. 1, 2022 (CN) 202211352837.3

(51) Int. Cl. G06V 20/13; G06V 10/764; G06V 20/10; G06V 20/56

(52) U.S. Cl. CPC G06V 20/13; G06V 10/764; G06V 20/10; G06V 20/56

(57) ABSTRACT

Provided are a multimodal fusion-based high-definition map feature recognition method and apparatus, a device, and a medium. The method includes determining attribute characteristics, pixel registration characteristics, and hybrid registration characteristics of a target map feature based on point cloud data and at least two types of candidate image data of the target map feature; determining a pixel correspondence of the target map feature based on the pixel registration characteristics of the target map feature and determining a hybrid correspondence of the target map feature based on the hybrid registration characteristics of the target map feature; and fusing the attribute characteristics of the target map feature based on the pixel correspondence and the hybrid correspondence to obtain a fused characteristic of the target map feature and determining a feature category of the target map feature based on the fused characteristic of the target map feature.

### CROSS-REFERENCE TO RELATED APPLICATIONS

This is a national stage application filed under 35 U.S.C. 371 based on International Patent Application No. PCT/CN2023/124320, filed on Oct. 12, 2023, which claims priority to Chinese Patent Application No. 202211352837.3 filed with the China National Intellectual Property Administration (CNIPA) on Nov. 1, 2022, the disclosures of which are incorporated herein by reference in their entireties.

### TECHNICAL FIELD

This disclosure relates to the field of artificial intelligence, in particular to the field of computer vision, for example, autonomous driving, high-definition (HD) maps, and intelligent transportation. This disclosure is applicable to high-definition map production scenarios.

### BACKGROUND

Compared with conventional maps, high-definition (HD) maps offer more precise information and more comprehensive content. High-definition maps can serve as an effective supplement to sensors, providing more reliable perception capabilities for autonomous driving systems.

Map features are the fundamental components of high-definition maps. Ensuring the accuracy of map feature recognition is essential for maintaining the map quality of high-definition maps and enhancing the perception and decision-making capabilities of autonomous driving systems.

### SUMMARY

This disclosure provides a multimodal fusion-based high-definition map feature recognition method, a device, and a medium.

According to an aspect of this disclosure, a multimodal fusion-based high-definition map feature recognition method is provided. The method includes determining attribute characteristics, pixel registration characteristics, and hybrid registration characteristics of a target map feature based on point cloud data and at least two types of candidate image data of the target map feature; determining a pixel correspondence of the target map feature based on the pixel registration characteristics of the target map feature and determining a hybrid correspondence of the target map feature based on the hybrid registration characteristics of the target map feature; and fusing the attribute characteristics of the target map feature based on the pixel correspondence and the hybrid correspondence to obtain a fused characteristic of the target map feature and determining a feature category of the target map feature based on the fused characteristic of the target map feature.

According to another aspect of this disclosure, an electronic device is provided. The electronic device includes at least one processor; and a memory communicatively connected to the at least one processor.

The memory stores instructions executable by the at least one processor to enable the at least one processor to perform the multimodal fusion-based high-definition map feature recognition method.

According to another aspect of this disclosure, a non-transitory computer-readable storage medium is provided. The storage medium stores computer instructions configured to cause a computer to perform the multimodal fusion-based high-definition map feature recognition method.

### BRIEF DESCRIPTION OF DRAWINGS

FIG. 1 is a flowchart of a multimodal fusion-based high-definition map feature recognition method according to an embodiment of this disclosure.

FIG. 2 is another flowchart of a multimodal fusion-based high-definition map feature recognition method according to an embodiment of this disclosure.

FIG. 3 is another flowchart of a multimodal fusion-based high-definition map feature recognition method according to an embodiment of this disclosure.

FIG. 4 is another flowchart of a multimodal fusion-based high-definition map feature recognition method according to an embodiment of this disclosure.

FIG. 5 is a diagram illustrating the structure of a multimodal fusion-based high-definition map feature recognition apparatus according to an embodiment of this disclosure.

FIG. 6 is a diagram illustrating the structure of a correspondence determination module according to an embodiment of this disclosure.

FIG. 7 is a diagram illustrating the structure of a target image selection submodule according to an embodiment of this disclosure.

FIG. 8 is a diagram illustrating the structure of a feature characteristic determination module according to an embodiment of this disclosure.

FIG. 9 is a diagram illustrating the structure of a feature characteristic determination module according to an embodiment of this disclosure.

FIG. 10 is a diagram illustrating the structure of a characteristic fusion module according to an embodiment of this disclosure.

FIG. 11 is a block diagram of an electronic device for implementing a multimodal fusion-based high-definition map feature recognition method according to an embodiment of this disclosure.

### DETAILED DESCRIPTION

Example embodiments of this disclosure, including details of embodiments of this disclosure, are described hereinafter in conjunction with drawings to facilitate understanding. The example embodiments are illustrative. For clarity and conciseness, descriptions of well-known functions and structures as well as descriptions of functions and structures not closely related to the embodiments described hereinafter are omitted.

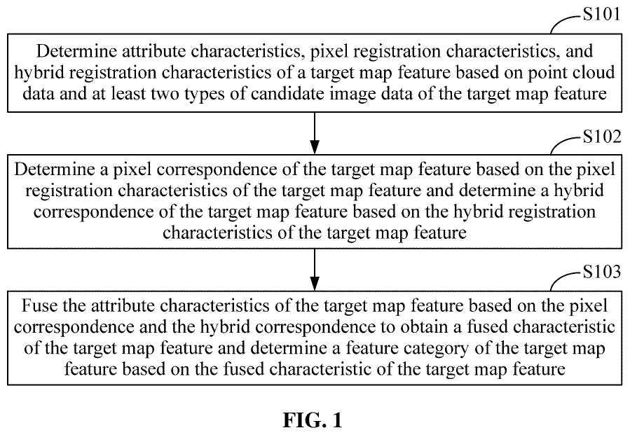

FIG. 1 is a flowchart of a multimodal fusion-based high-definition map feature recognition method according to an embodiment of this disclosure. This embodiment of this disclosure is applicable to high-definition map production scenarios. The multimodal fusion-based high-definition map feature recognition method may be executed by a multimodal fusion-based high-definition map feature recognition apparatus. This apparatus may be implemented by software and/or hardware and can be integrated into an electronic device that supports multimodal fusion-based high-definition map feature recognition. As shown in FIG. 1, the multimodal fusion-based high-definition map feature recognition method of the present application may include the following:

In S101, attribute characteristics, pixel registration characteristics, and hybrid registration characteristics of a target map feature are determined based on point cloud data and at least two types of candidate image data of the target map feature.

In S102, a pixel correspondence of the target map feature is determined based on the pixel registration characteristics of the target map feature, and a hybrid correspondence of the target map feature is determined based on the hybrid registration characteristics of the target map feature.

In S103, the attribute characteristics of the target map feature are fused based on the pixel correspondence and the hybrid correspondence to obtain a fused characteristic of the target map feature, and a feature category of the target map feature is determined based on the fused characteristic of the target map feature.

The target map feature is used for high-definition map production. High-definition maps are distinguished from conventional maps by offering more precise information and more comprehensive content. The target map feature constitutes the fundamental content of a high-definition map. In an embodiment, the target map feature refers to a geographic feature in a high-definition map. In an embodiment, the target map feature is a traffic-related feature. Traffic-related features include ground traffic markings such as lane markings and above-ground traffic signs such as traffic lights. In an embodiment, the target map feature is a lane marking. Lane marking recognition is an important component of a visual perception task. An accurate lane marking recognition technology can provide reliable information guidance for an autonomous driving system. The multimodal fusion-based high-definition map feature recognition method provided by the embodiment of this disclosure can accurately identify the category of the lane marking and effectively ensure the scenario applicability of the method provided by the embodiment of this disclosure.

The point cloud data and the candidate image data of the target map feature describe the target map feature from a three-dimensional perspective and a two-dimensional perspective, respectively. Compared with the point cloud data, the candidate image data contains richer feature textures and can serve as a critical reference in the process of determining the feature category of the target map feature. In contrast, the point cloud data can accurately depict the feature position of the target map feature in a three-dimensional space, which is unmatchable by the candidate image data. The feature category and the feature position of the target map feature serve as the data foundation for high-definition map production.

The candidate image data in this disclosure are acquired by different types of image acquisition devices, with at least two types of candidate image data involved. Affected by shooting conditions (for example, shooting angle) and device-specific parameters (for example, calibration parameters) of the image acquisition devices, different candidate image data differ in quality. As a result, the attribute characteristics of the target map feature determined based on different candidate image data also differ. The greater the variety of the candidate image data, the richer the attribute characteristics extracted from the candidate image data; however, this also leads to increased computational resource consumption in processing the attribute characteristics. The types of the candidate image data are determined based on actual service requirements and are not limited herein.

In an embodiment, the at least two types of candidate image data include data of at least two of a fused image, a panoramic image, and an industrial camera image.

A fused image refers to a road image generated by fusing point cloud data and image data. A fused image has high positioning accuracy. The pixel coordinates of a fused image can be mapped to latitude and longitude. However, a fused image has problems such as low color clarity, difficulty in distinguishing between color information of map features, misalignment during the stitching process caused by edge distortion, and missing data in occluded areas. When the target map feature is a ground traffic marking such as a lane marking, a fused image is similar to an aerial view that describes the map feature from a top-down perspective. When the target map feature is an above-ground traffic sign, the candidate image data may be images that describe the map feature from other perspectives.

A panoramic image has the advantages of high clarity and rich color information of map features. Feature categories in a panoramic image can be distinguished even when ground traffic markings are occluded. However, without strict parameter calibration, a panoramic image cannot provide accurate positioning. In addition, in a panoramic image, the field of view is easily obstructed by objects, and the continuity of capturing ground traffic markings is poor.

An industrial camera image refers to an image captured by a high-speed industrial camera. A high-speed industrial camera used for capturing industrial camera images is strictly calibrated and satisfies the conditions for point cloud registration. The above types of image data do not limit this embodiment of this disclosure. The candidate image data is not limited to such data and may also include image data acquired by other image acquisition devices.

In terms of feature position determination and feature category recognition, different candidate image data provide different reference values. If only one type of candidate image data is fused with point cloud data to generate a fused characteristic for determining the feature category of the target map feature, low recognition accuracy may occur. This is because relying on only one type of candidate image data fused with point cloud data cannot ensure the accuracy of both hybrid registration characteristics and attribute characteristics.

In the related art, feature category recognition of map features is mostly based on a fused image obtained by fusing point cloud data and image data. Although a fused image offers high positioning accuracy, it suffers from problems such as low color clarity and poor distinguishability of the color information of map features. As a result, the accuracy of attribute characteristics determined based on a fused image cannot be ensured, leading to low accuracy in recognizing the feature category to which the map feature belongs and requiring considerable manual effort in correction during subsequent stages.

The technical solution of this disclosure fuses at least two of the fused image, the panoramic image, and the industrial camera image with the point cloud data. By utilizing multimodal image data for map feature recognition, this technical solution compensates for the limitations of single-type data and improves the accuracy of map feature recognition. During a high-definition map production process, the manual correction cost of map features can be reduced.

The attribute characteristics of the target map feature are used for determining the feature category to which the target map feature belongs. In an embodiment, the attribute characteristics are appearance characteristics. For example, the appearance characteristics may include the shape characteristics and/or color characteristics of the target map feature.

Based on the point cloud data and the at least two types of candidate image data of the target map feature, the attribute characteristics of the target map feature are extracted separately. Characteristic extraction is performed on the point cloud data and the at least two types of candidate image data of the target map feature separately to obtain attribute characteristics belonging to the point cloud data and attribute characteristics belonging to the candidate image data. The candidate image data are in at least two types. The attribute characteristics obtained from the candidate image data are also in at least two types. In an embodiment, a deep neural network-based semantic segmentation model such as DeepLabV3 is used to segment the target map feature and extract the attribute characteristics of the target map feature, or a deep neural network-based object classification model such as Faster Region-Convolutional Neural Network (RCNN) is used to recognize the target map feature and extract the attribute characteristics of the target map feature. For the point cloud data, a voxel-based semantic segmentation model such as PointNet++ may be used to segment the target map feature and extract the attribute characteristics of the target map feature.

The attribute characteristics belonging to at least two types of image data and the attribute characteristics belonging to the point cloud data are jointly used to determine the feature category to which the target map feature belongs. Based on the pixel correspondence and the hybrid correspondence, the attribute characteristics of the target map feature are fused to obtain the fused characteristic of the target map feature. The feature category of the target map feature is then determined based on the fused characteristic of the target map feature.

The pixel correspondence refers to the correspondence between pixel coordinates in different candidate image data. Based on the pixel correspondence, the target map feature may be determined from different candidate image data. The pixel correspondence is determined based on the pixel registration characteristics. The pixel registration characteristics are used for registering different candidate image data.

The hybrid correspondence refers to the correspondence between the point cloud data and the candidate image data. In an embodiment, the hybrid correspondence may be the correspondence between the point cloud data and any one type of the at least two types of candidate image data. In an embodiment, the candidate image data used to determine the hybrid correspondence satisfies a point cloud registration condition. The point cloud registration condition refers to the condition for registration between image data and point cloud data. The point cloud registration condition is determined based on device parameters of the image acquisition device. Based on the hybrid correspondence, the target map feature may be determined from the point cloud data and the candidate image data.

The hybrid correspondence is determined based on the hybrid registration characteristics. The hybrid registration characteristics include hybrid registration characteristics belonging to the point cloud data and hybrid registration characteristics belonging to the candidate image data. The hybrid registration characteristics are used for registering the point cloud data with the candidate image data.

The hybrid correspondence and the pixel correspondence bridge the data barrier between the at least two types of candidate image data and the point cloud data, enabling the association of attribute characteristics belonging to the point cloud data with attribute characteristics belonging to the at least two types of image data. This provides guidance for the fusion of attribute characteristics from different data sources.

The attribute characteristics of the target map feature are fused based on the hybrid correspondence and the pixel correspondence to obtain the fused characteristic of the target map feature, ensuring the accuracy of characteristic fusion.

The fused characteristic of the target map feature includes both attribute characteristics extracted from the point cloud data and attribute characteristics extracted from the at least two types of candidate image data. Compared with attribute characteristics from a single source, the fused characteristic is more comprehensive, enabling a more complete and accurate representation of the feature category of the target map feature. Determining the feature category of the target map feature based on the fused characteristic of the target map feature can improve the accuracy of feature category recognition.

In this embodiment of this disclosure, the feature category to which the target map feature belongs is determined based on point cloud data and at least two types of candidate image data. This effectively compensates for the limitations of using a single data source, improves the accuracy of recognizing the feature category to which the target map feature belongs, and reduces the cost of high-definition map production. In this embodiment of this disclosure, the pixel correspondence and the hybrid correspondence of the target map feature are determined based on the pixel registration characteristics and the hybrid registration characteristics respectively, and the pixel correspondence and the hybrid correspondence are applied to the fusion of characteristics. This breaks down the data barrier between the point cloud data and the at least two types of candidate image data, establishes a correlation between the point cloud data and the at least two types of candidate image data, and provides guidance for the fusion of the attribute characteristics and data support for fusing the point cloud data with multimodal image data, thereby improving the accuracy of recognizing the feature category to which the target map feature belongs.

In an embodiment, the method also includes determining a feature position of the target map feature based on the point cloud data; associating the feature position with the feature category of the target map feature based on the hybrid correspondence; and generating a high-definition map based on the feature position and the feature category of the target map feature.

The feature position refers to the position coordinates of the target map feature in a three-dimensional space. The feature position is determined based on the point cloud data that can accurately depict the position of the target map feature in the three-dimensional space. This is an advantage that candidate image data cannot match. Compared with the point cloud data, the candidate image data contains richer feature textures and can serve as a critical reference in the process of determining the feature category of the target map feature.

The hybrid correspondence refers to the correspondence between the point cloud data and the candidate image data. Based on the hybrid correspondence, the feature position of the target map feature can be associated with the feature category of the target map feature. The feature category and the feature position of the target map feature serve as the data foundation for high-definition map production. The high-definition map is generated based on the feature position and the feature category of the target map feature.

In an embodiment, when the candidate image data is a fused image such as an aerial view generated by fusing the point cloud data and the image data, the feature position of the target map feature is determined based on the fused image. Correspondingly, the feature position is associated with the feature category of the target map feature based on the hybrid correspondence.

This solution associates the feature position of the target map feature with the feature category of the target map feature based on the hybrid correspondence and generates the high-definition map based on the feature position and the feature category of the target map feature, providing data support for high-definition map production.

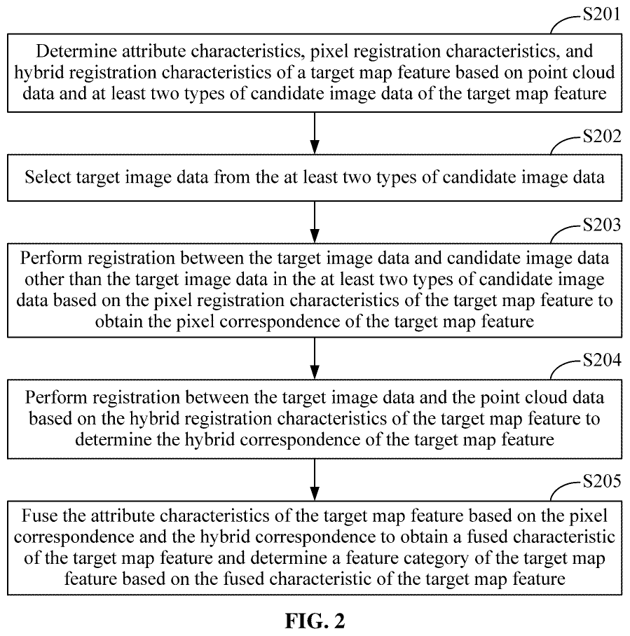

FIG. 2 is another flowchart of a multimodal fusion-based high-definition map feature recognition method according to an embodiment of this disclosure. This embodiment is a solution provided based on the preceding embodiments. In this embodiment of this disclosure, the operation “a pixel correspondence of the target map feature is determined based on the pixel registration characteristics of the target map feature, and a hybrid correspondence of the target map feature is determined based on the hybrid registration characteristics of the target map feature” is described.

Referring to FIG. 2, the multimodal fusion-based high-definition map feature recognition method includes the following:

In S201, attribute characteristics, pixel registration characteristics, and hybrid registration characteristics of a target map feature are determined based on point cloud data and at least two types of candidate image data of the target map feature.

In S202, target image data is selected from the at least two types of candidate image data.

The target image data satisfies a point cloud registration condition. The point cloud registration condition refers to the condition for registration between the image data and the point cloud data. The point cloud registration condition is determined based on the device parameters of the image acquisition device. The target image data serves as a bridge connecting different candidate image data and associating the point cloud data with the candidate image data. The target image data is used for determining the hybrid correspondence and the pixel correspondence.

In S203, registration is performed between the target image data and candidate image data other than the target image data in the at least two types of candidate image data based on the pixel registration characteristics of the target map feature to obtain the pixel correspondence of the target map feature.

The pixel registration condition is used for registering different candidate images. Each type of candidate image data has the corresponding pixel registration characteristic. Based on the pixel registration characteristics, the target image data is registered with other image data except the target image data. Associations are established between different candidate image data and used as the pixel correspondence.

In S204, registration is performed between the target image data and the point cloud data based on the hybrid registration characteristics of the target map feature to determine the hybrid correspondence of the target map feature.

The hybrid correspondence is used for registration between the point cloud data and the target image data. Based on the hybrid registration characteristics of the target map feature, the target image data is registered with the point cloud data. An association is determined between the target image data and the point cloud data and used as the hybrid correspondence.

In S205, the attribute characteristics of the target map feature are fused based on the pixel correspondence and the hybrid correspondence to obtain a fused characteristic of the target map feature, and a feature category of the target map feature is determined based on the fused characteristic of the target map feature.

The hybrid correspondence records the correspondence between the target image data and the point cloud data. The pixel correspondence records the correspondence between the target image data and other candidate image data except the target image data. The hybrid correspondence and the pixel correspondence can associate the point cloud data with the at least two types of candidate image data. The hybrid correspondence and the pixel correspondence are used for guiding the fusion of the attribute characteristics.

In this embodiment of this disclosure, the target image data is determined from the at least two types of candidate image data. The target image data serves as a bridge connecting different candidate image data and associating the candidate image data with the point cloud data. Based on the target image data, the pixel correspondence and the hybrid correspondence are determined, breaking down the data barrier between different types of data. This enables the fusion of the at least two types of candidate image data with the point cloud data and provides technical support for using multimodal image data in feature category recognition.

In an embodiment, performing the registration between the target image data and the candidate image data other than the target image data based on the pixel registration characteristics of the target map feature to obtain the pixel correspondence of the target map feature includes performing registration between pixel coordinates of the target map feature in the target image data and pixel coordinates of the target map feature in the candidate image data other than the target image data based on the pixel registration characteristics of the target map feature to obtain the pixel correspondence of the target map feature.

In an embodiment, pixel-level registration is performed between different candidate image data. The pixel correspondence refers to the correspondence between pixel coordinates. Based on the pixel registration characteristics of the target map feature, the pixel coordinates of the target map feature in the target image data are determined as first pixel coordinates. Based on the pixel registration characteristics of the target map feature, the pixel coordinates of the target map feature in other candidate image data except the target image data are determined as second pixel coordinates. The first pixel coordinates and the second pixel coordinates are then registered to obtain the pixel correspondence of the target map feature.

In this embodiment of this disclosure, “first” and “second” are used to distinguish between different candidate image data. X\hat{ }I represents the target image data. Y\hat{ }I represents other candidate image data except the target image data. The pixel correspondence may be represented as X\hat{ }I={p_1\hat{ }(X\hat{ }I), p_2\hat{ }(X\hat{ }I), . . . , p_K\hat{ }(X\hat{ }I)}, Y\hat{ }I={p_1\hat{ }(Y\hat{ }I), p_2\hat{ }(Y\hat{ }I), . . . , p_K\hat{ }(Y\hat{ }I)}. p_K\hat{ }(X\hat{ }I) represents the pixel coordinates of pixel p_K of the target map feature in X\hat{ }I. p_K\hat{ }(Y\hat{ }I) represents the pixel coordinates of pixel p_K of the target map feature in Y\hat{ }I. K is a positive integer determined by the number of pixels of the target map feature.

In an embodiment, performing the registration between the target image data and the point cloud data based on the hybrid registration characteristics of the target map feature to determine the hybrid correspondence of the target map feature includes performing registration between pixel coordinates of the target map feature in the target image data and point cloud coordinates of the target map feature in the point cloud data based on the hybrid registration characteristics of the target map feature to obtain the hybrid correspondence of the target map feature.

The hybrid correspondence refers to the correspondence between the point cloud coordinates and the pixel coordinates. Based on the pixel registration characteristics, the pixel coordinates of the target map feature in the target image data are determined. Based on the hybrid registration characteristics, the point cloud coordinates of the target map feature in the point cloud data are determined. The pixel coordinates are registered with the point cloud coordinates to obtain the hybrid correspondence of the target map feature. The mapping of three-dimensional point cloud coordinates to two-dimensional pixel coordinates can be implemented based on the hybrid correspondence.

This solution performs pixel-level registration of data from different sources, providing a method for determining the pixel correspondence and a method for determining the hybrid correspondence. This offers data support for the subsequent fusion of the attribute characteristics of the target map feature based on the pixel correspondence and the hybrid correspondence, thereby ensuring the accuracy of characteristic fusion.

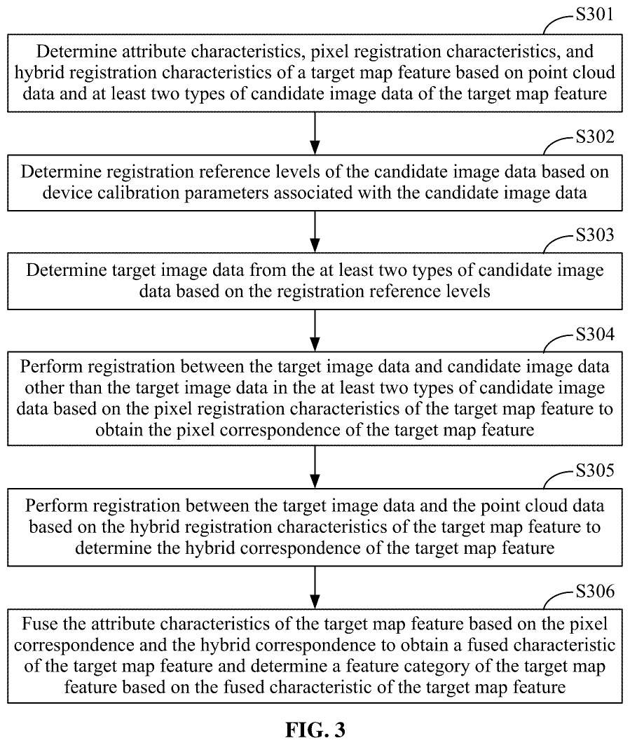

FIG. 3 is another flowchart of a multimodal fusion-based high-definition map feature recognition method according to an embodiment of this disclosure. This embodiment is a solution provided based on the preceding embodiments. In this embodiment of this disclosure, the operation “target image data is selected from the at least two types of candidate image data” is described.

Referring to FIG. 3, the multimodal fusion-based high-definition map feature recognition method includes the following:

In S301, attribute characteristics, pixel registration characteristics, and hybrid registration characteristics of a target map feature are determined based on point cloud data and at least two types of candidate image data of the target map feature.

In S302, registration reference levels of the at least two types of candidate image data are determined based on device calibration parameters associated with the candidate image data.

The device calibration parameter refers to the calibration parameter of the image acquisition device. The device calibration parameters are determined based on the intrinsic parameters and the extrinsic parameters of the image acquisition device. Due to the differences in the image acquisition devices that generate different candidate image data, the device calibration parameters associated with different candidate image data vary. Based on the device calibration parameters, the probability of distortion of the candidate image data can be determined.

Based on the device calibration parameters, the registration reference levels of the candidate image data can be determined. The registration reference levels are used for measuring the point cloud registration condition of the candidate image data. Generally, the registration reference level of an industrial camera image strictly calibrated is higher than the registration reference level of a panoramic image.

In S303, the target image data is determined from the at least two types of candidate image data based on the registration reference levels.

Generally, the higher the registration reference level, the more likely the associated candidate image data is to satisfy the point cloud registration condition. In an embodiment, the candidate image data with the highest registration reference level is selected as the target image data.

In S304, registration is performed between the target image data and candidate image data other than the target image data in the at least two types of candidate image data based on the pixel registration characteristics of the target map feature to obtain the pixel correspondence of the target map feature.

In S305, registration is performed between the target image data and the point cloud data based on the hybrid registration characteristics of the target map feature to determine the hybrid correspondence of the target map feature.

In S306, the attribute characteristics of the target map feature are fused based on the pixel correspondence and the hybrid correspondence to obtain a fused characteristic of the target map feature, and a feature category of the target map feature is determined based on the fused characteristic of the target map feature.

In this embodiment of this disclosure, the registration reference levels of the at least two types of candidate image data are determined based on the device calibration parameters associated with the candidate image data. Based on the registration reference levels, the target image data is selected from the at least two types of candidate image data. As a bridge connecting data from different sources, the target image data is used to determine the pixel correspondence and the hybrid correspondence. The target image data is the key to breaking the data barrier between the point cloud data and the candidate image data. This ensures the accuracy of the selected target image data, providing technical support for the fusion of the at least two types of candidate image data with the point cloud data and for feature category recognition using multimodal image data.

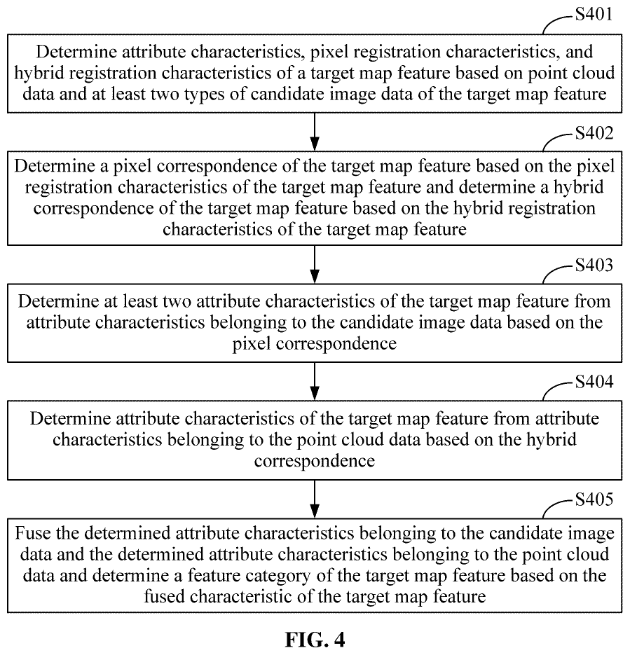

FIG. 4 is another flowchart of a multimodal fusion-based high-definition map feature recognition method according to an embodiment of this disclosure. This embodiment is a solution provided based on the preceding embodiments. In this embodiment of this disclosure, the operation “the attribute characteristics of the target map feature are fused based on the pixel correspondence and the hybrid correspondence to obtain a fused characteristic of the target map feature” is described.

Referring to FIG. 4, the multimodal fusion-based high-definition map feature recognition method includes the following:

In S401, attribute characteristics, pixel registration characteristics, and hybrid registration characteristics of a target map feature are determined based on point cloud data and at least two types of candidate image data of the target map feature.

The attribute characteristics of the target map feature include attribute characteristics determined based on the point cloud data and attribute characteristics determined based on the at least two types of candidate image data.

In S402, a pixel correspondence of the target map feature is determined based on the pixel registration characteristics of the target map feature, and a hybrid correspondence of the target map feature is determined based on the hybrid registration characteristics of the target map feature.

In S403, at least two attribute characteristics of the target map feature are determined from attribute characteristics belonging to the candidate image data based on the pixel correspondence.

The attribute characteristics belonging to the candidate image data refer to the attribute characteristics determined based on the candidate image data. Each type of candidate image data has the corresponding attribute characteristic. The number of attribute characteristics belonging to the candidate image data is determined based on the types of the candidate image data. By way of example, when the at least two types of candidate image data include fused image data, panoramic image data, and industrial camera image data, each of the three types of candidate image data has the corresponding attribute characteristic.

Generally, the candidate image data include not only the target map feature but also other map features.

In an embodiment, the pixel coordinates of the target map feature in any candidate image data are determined. Based on the pixel coordinates and the pixel correspondence, at least two attribute characteristics of the target map feature are determined from the attribute characteristics belonging to the candidate image data.

In S404, attribute characteristics of the target map feature are determined from attribute characteristics belonging to the point cloud data based on the hybrid correspondence.

The attribute characteristics belonging to the point cloud data refer to the attribute characteristics determined based on the point cloud data. Similarly, in the point cloud data, in addition to the target map feature, other map features may also be included.

In an embodiment, when the pixel coordinates of the target map feature are determined, the attribute characteristics of the target map feature are determined from the attribute characteristics belonging to the point cloud data based on the pixel coordinates and the hybrid correspondence.

In S405, the determined attribute characteristics belonging to the candidate image data and the determined attribute characteristics belonging to the point cloud data are fused, and a feature category of the target map feature is determined based on the fused characteristic of the target map feature.

In this embodiment of this disclosure, at least two attribute characteristics of the target map feature are determined from the attribute characteristics belonging to the candidate image data based on the pixel correspondence, and the attribute characteristics of the target map feature are determined from the attribute characteristics belonging to the point cloud data based on the hybrid correspondence, ensuring the accuracy of attribute characteristic selection and improving the accuracy of feature category recognition.

In an embodiment, determining the pixel registration characteristics of the target map feature based on the at least two types of candidate image data of the target map feature includes determining a key pixel of the target map feature based on the at least two types of candidate image data; and determining the pixel registration characteristics of the target map feature based on a pixel characteristic of the key pixel.

The key pixel refers to a pixel that can provide effective reference for image registration. The key pixel is a representative pixel of the target map feature and generally has a large gradient. The key pixel is often located at the contour edge of the target map feature. By way of example, the key pixel may be corner points of the target map feature.

The pixel characteristic of the key pixel is extracted. The pixel registration characteristics of the target map feature are determined based on the pixel characteristic of the key pixel.

The pixel registration characteristics may be obtained by performing characteristic extraction on the candidate image data using an image registration algorithm. By way of example, the pixel registration characteristics may be corner point characteristics. The pixel registration characteristics match the image registration algorithm. The type of the pixel registration characteristics is not limited here and can be determined based on the actual situation.

This technical solution provides a feasible method for determining the pixel registration characteristics, ensuring the accuracy of the pixel registration characteristics and providing data support for determining the pixel correspondence and for using the pixel correspondence in the fusion of the attribute characteristics.

In an embodiment, determining the hybrid registration characteristics of the target map feature based on the point cloud data and the at least two types of candidate image data of the target map feature includes determining device calibration parameters associated with the at least two types of candidate image data; and determining the hybrid registration characteristics of the target map feature based on the device calibration parameters, pixel coordinates of the target map feature in the at least two types of candidate image data, and point cloud coordinates of the target map feature in the point cloud data.

The device calibration parameters include intrinsic parameters and extrinsic parameters. The device calibration parameters are determined during the device calibration process. The device calibration parameters are used for establishing the relationship between the pixel positions of the candidate image data and the scene point positions.

The hybrid registration characteristics are determined based on the device calibration parameters, pixel coordinates of the target map feature in the at least two types of candidate image data, and point cloud coordinates of the target map feature in the point cloud data. The hybrid registration characteristics enable the mapping of three-dimensional point cloud coordinates to two-dimensional pixel coordinates.

This technical solution provides a feasible method for determining the hybrid registration characteristics, ensuring the accuracy of the hybrid registration characteristics and providing data support for determining the hybrid correspondence and for using the hybrid correspondence in the fusion of the attribute characteristics.

In an embodiment, when the at least two types of candidate image data include fused image data, panoramic image data, and industrial camera image data, lane marking recognition is performed using the multimodal fusion-based high-definition map feature recognition method of this disclosure.

Different types of lane markings differ in linearity and color. By way of example, the colors of lane markings include white, yellow, and one yellow and one white (double lines). The styles of lane markings include a single solid line, double solid lines, a single dashed line, double dashed lines, and one dashed line and one solid line. The recognition of lane markings is to recognize the type of lane markings based on the attribute characteristics of lane markings, such as color and style.

First, the attribute characteristics of a lane marking are determined based on the point cloud data, the fused image data, the panoramic image data, and the industrial camera image data of the lane marking. The fused image data, the panoramic image data, the industrial camera image data, and the point cloud data are labeled separately. A lane marking recognition model is pre-trained to obtain model set M, where M=(m1, m2, m3, m4). For the candidate image data such as the fused image data, the panoramic image data, and the industrial camera image data, a semantic segmentation model based on a deep neural network, such as DeepLabV3, may be used to segment the lane marking and determine the attribute information of the lane marking, or an object classification model based on a deep neural network, such as Faster-RCNN, may be used to recognize the lane marking from the candidate image data and determine the attribute information of the lane marking.

For the point cloud data, a voxel-based semantic segmentation model such as PointNet++ may be used to segment the lane marking and extract the attribute characteristics of the lane marking. Based on the model set formed by the lane marking recognition model, the extracted attribute characteristics of the lane marking are represented by attribute characteristic set A, where A=(a1, a2, a3, a4). a1 indicates the attribute characteristics extracted by model m1 from the fused image. a1 is an n1×n2 two-dimensional matrix, where the element a1[x, y] represents the attribute characteristics of the lane marking at pixel point (x, y). a2 indicates the attribute characteristics extracted by model m2 from the panoramic image. a3 indicates the attribute characteristics extracted by model m3 from the industrial camera image. Both a2 and a3 are two-dimensional matrices, similar to a1, where the elements in the matrices are the attribute characteristics of the lane marking. a4 indicates the attribute characteristics extracted by model m4 from the point cloud data. a4 is an n4×4 two-dimensional matrix, where n4 is the number of point clouds. Each row in matrix a4 records the three-dimensional spatial coordinates x4, y4, z4 of a point cloud and the attribute characteristic s4 of the lane marking.

In addition to extracting the attribute characteristics of the lane marking based on the candidate image data and the point cloud data, the pixel registration characteristics and the hybrid registration characteristics of the lane marking are also extracted based on the candidate image data and the point cloud data.

The pixel registration characteristics are determined based on the pixel characteristic of the key pixel in the lane marking. The pixel registration characteristics are determined using an image registration algorithm. The hybrid registration characteristics are determined based on the device calibration parameters, the pixel coordinates of the lane marking in the candidate image data, and the point cloud coordinates of the lane marking in the point cloud data. The pixel registration characteristics and the hybrid registration characteristics are used to determine the pixel correspondence and the hybrid correspondence respectively.

The industrial camera image in the candidate image data is determined as the target image data because the high-speed industrial camera that captures the industrial camera image undergoes strict parameter calibration, satisfying the point cloud registration condition.

Based on the pixel registration characteristics, the industrial camera image data is registered with the panoramic image to obtain the pixel correspondence. Based on the hybrid registration characteristics, the industrial camera image data is registered with the point cloud data to obtain the hybrid correspondence. The hybrid correspondence and the pixel correspondence are used to break the data barrier between the point cloud data and the at least two types of candidate image data, thereby establishing correspondences between the point cloud data, the panoramic image, and the industrial camera image. The fused image is not involved in determining the pixel correspondence because the fused image is obtained by fusing the point cloud data with the image data, that is, the fused image has already been associated with the point cloud data. This helps save computational resources.

Next, based on the pixel correspondence and the hybrid correspondence, the attribute characteristics of the lane marking are fused to obtain the fused characteristic of the lane marking. The category of the lane marking is determined based on the fused characteristic of the lane marking. The attribute characteristics belonging to different types of data are fused by using the Bayesian characteristic fusion algorithm. Then the lane marking category with high confidence is determined by a decision fusion model.

Given that the attribute Ω of the lane marking includes C categories, denoted as Ω=(ω1, ω2, . . . , ωC), attribute characteristic set A as data input is input into the decision fusion model, if the decision fusion model classifies sample A as the ωj^{th} category according to the Bayesian decision theory with the minimum error rate, this ωj^{th} category is the mode category with the highest posterior probability under the condition of known sample A.

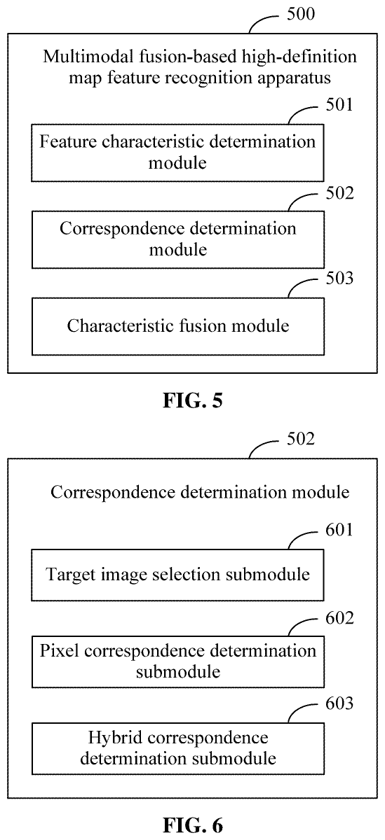

FIG. 5 is a diagram illustrating the structure of a multimodal fusion-based high-definition map feature recognition apparatus according to an embodiment of this disclosure. The embodiment of this disclosure is applicable to high-definition map production scenarios. This apparatus can be implemented by software and/or hardware. This apparatus can perform the multimodal fusion-based high-definition map feature recognition method of any embodiment of this disclosure. As shown in FIG. 5, the multimodal fusion-based high-definition map feature recognition apparatus 500 includes a feature characteristic determination module 501, a correspondence determination module 502, and a characteristic fusion module 503.

The feature characteristic determination module 501 is configured to determine attribute characteristics, pixel registration characteristics, and hybrid registration characteristics of a target map feature based on point cloud data and at least two types of candidate image data of the target map feature; the correspondence determination module 502 is configured to determine a pixel correspondence of the target map feature based on the pixel registration characteristics of the target map feature and determine a hybrid correspondence of the target map feature based on the hybrid registration characteristics of the target map feature; and the characteristic fusion module 503 is configured to fuse the attribute characteristics of the target map feature based on the pixel correspondence and the hybrid correspondence to obtain a fused characteristic of the target map feature and determine a feature category of the target map feature based on the fused characteristic of the target map feature.

In this embodiment of this disclosure, the feature category of the target map feature is determined based on point cloud data and at least two types of candidate image data. This effectively compensates for the limitations of using a single data source, improves the accuracy of recognizing the feature category to which the target map feature belongs, and facilitates the reduction in the cost of high-definition map production. In this embodiment of this disclosure, the pixel correspondence and the hybrid correspondence of the target map feature are determined based on the pixel registration characteristics and the hybrid registration characteristics, respectively. This breaks down the data barrier between the point cloud data and the at least two types of candidate image data, establishes a correlation between the point cloud data and the at least two types of candidate image data, and provides guidance for the fusion of the attribute characteristics and data support for fusing the point cloud data with multimodal image data, thereby improving the accuracy of recognizing the feature category to which the target map feature belongs.

In an embodiment, as shown in FIG. 6, the correspondence determination module 502 includes a target image selection submodule 601 configured to select target image data from the at least two types of candidate image data; a pixel correspondence determination submodule 602 configured to perform registration between the target image data and candidate image data other than the target image data in the at least two types of candidate image data based on the pixel registration characteristics of the target map feature to obtain the pixel correspondence of the target map feature; and a hybrid correspondence determination submodule 603 configured to perform registration between the target image data and the point cloud data based on the hybrid registration characteristics of the target map feature to determine the hybrid correspondence of the target map feature.

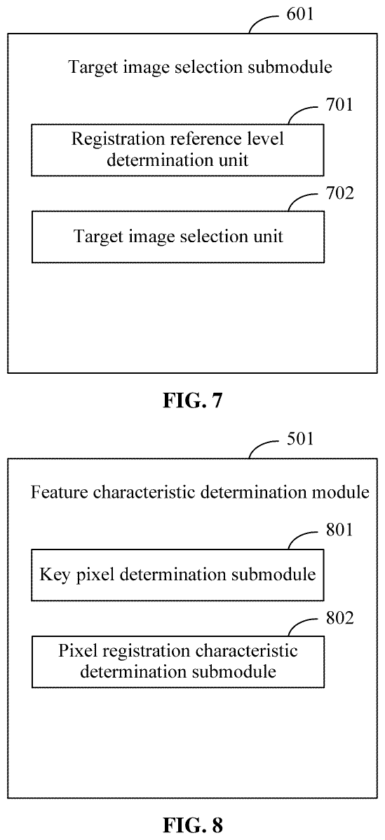

In an embodiment, as shown in FIG. 7, the target image selection submodule 601 includes a registration reference level determination unit 701 configured to determine registration reference levels of the at least two types of candidate image data based on device calibration parameters associated with the at least two types of candidate image data; and a target image selection unit 702 configured to determine the target image data from the at least two types of candidate image data based on the registration reference levels.

In an embodiment, the pixel correspondence determination submodule 602 is configured to perform registration between pixel coordinates of the target map feature in the target image data and pixel coordinates of the target map feature in candidate image data other than the target image data in the at least two types of candidate image data based on the pixel registration characteristics of the target map feature to obtain the pixel correspondence of the target map feature.

In an embodiment, the hybrid correspondence determination submodule 603 is configured to perform registration between pixel coordinates of the target map feature in the target image data and point cloud coordinates of the target map feature in the point cloud data based on the hybrid registration characteristics of the target map feature to obtain the hybrid correspondence of the target map feature.

In an embodiment, as shown in FIG. 8, the feature characteristic determination module 501 includes a key pixel determination submodule 801 configured to determine a key pixel of the target map feature based on the at least two types of candidate image data; and a pixel registration characteristic determination submodule 802 configured to determine the pixel registration characteristics of the target map feature based on a pixel characteristic of the key pixel.

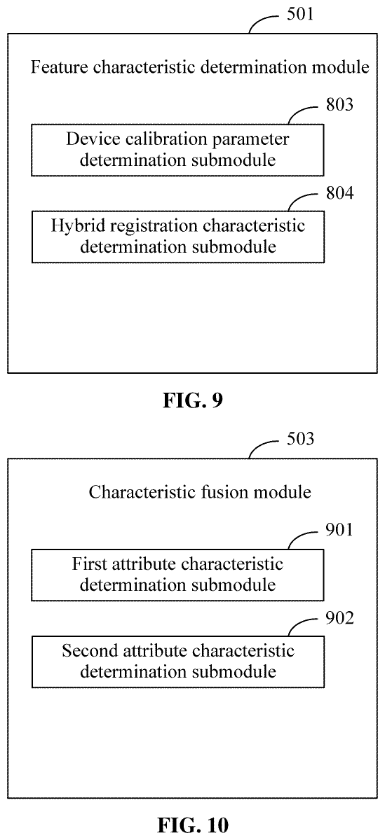

In an embodiment, as shown in FIG. 9, the feature characteristic determination module 501 includes a device calibration parameter determination submodule 803 configured to determine device calibration parameters associated with the at least two types of candidate image data; and a hybrid registration characteristic determination submodule 804 configured to determine the hybrid registration characteristics of the target map feature based on the device calibration parameters, pixel coordinates of the target map feature in the at least two types of candidate image data, and point cloud coordinates of the target map feature in the point cloud data.

In an embodiment, as shown in FIG. 10, the characteristic fusion module 503 includes a first attribute characteristic determination submodule 901 configured to determine at least two attribute characteristics of the target map feature from attribute characteristics belonging to the at least two types of candidate image data based on the pixel correspondence; a second attribute characteristic determination submodule 902 configured to determine attribute characteristics of the target map feature from attribute characteristics belonging to the point cloud data based on the hybrid correspondence; and fuse the determined at least two attribute characteristics belonging to the at least two types of candidate image data and the determined attribute characteristics belonging to the point cloud data.

In an embodiment, the apparatus also includes 504 a feature position determination module configured to determine a feature position of the target map feature based on the point cloud data; a feature category determination module configured to associate the feature position with the feature category of the target map feature based on the hybrid correspondence; and a high-definition map generation module configured to generate a high-definition map based on the feature position and the feature category of the target map feature.

In an embodiment, the target map feature is a lane marking.

In an embodiment, the at least two types of candidate image data include at least two of fused image data, panoramic image data, and industrial camera image data.

The multimodal fusion-based high-definition map feature recognition apparatus provided by this embodiment of this disclosure can perform the multimodal fusion-based high-definition map feature recognition method of any embodiment of this disclosure and has function modules and beneficial effects corresponding to the performed method.

In the technical solutions of this disclosure, the collection, storage, use, processing, transmission, provision, and disclosure of client information involved are in compliance with provisions of relevant laws and regulations and do not violate public order and good customs.

According to embodiments of this disclosure, this disclosure also provides an electronic device, a readable storage medium, and a computer program product.

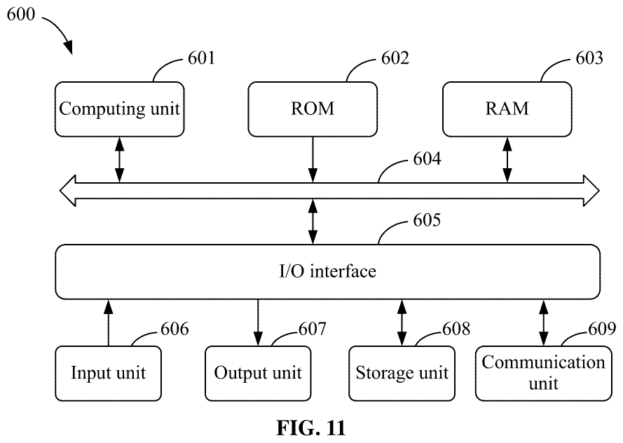

FIG. 11 is a block diagram of an electronic device for implementing a multimodal fusion-based high-definition map feature recognition method according to an embodiment of this disclosure. Electronic devices 600 are intended to represent various forms of digital computers, for example, laptop computers, desktop computers, worktables, personal digital assistants, servers, blade servers, mainframe computers and other applicable computers. The electronic device may further represent various forms of mobile apparatuses, for example, a personal digital assistant, a cellphone, a smartphone, a wearable device, and another similar computing apparatus. Herein the shown components, the connections and relationships between these components, and the functions of these components are illustrative and are not intended to limit the implementation of this disclosure as described and/or claimed herein.

As shown in FIG. 11, the device 600 includes a computing unit 601. The computing unit 601 may perform various types of appropriate operations and processing based on a computer program stored in a read-only memory (ROM) 602 or a computer program loaded from a storage unit 608 to a random-access memory (RAM) 603. The RAM 603 may also store various programs and data required for the operation of the electronic device 600. The computing unit 601, the ROM 602, and the RAM 603 are connected to each other through a bus 604. An input/output (I/O) interface 605 is also connected to the bus 604.

Multiple components in the electronic device 600 are connected to the I/O interface 605. The multiple components include an input unit 606 such as a keyboard and a mouse, an output unit 607 such as various types of displays and speakers, the storage unit 608 such as a magnetic disk and an optical disk, and a communication unit 609 such as a network card, a modem, and a wireless communication transceiver. The communication unit 609 allows the electronic device 600 to exchange information/data with other devices over a computer network such as the Internet and/or various telecommunications networks.

The computing unit 601 may be various general-purpose and/or special-purpose processing components having processing and computing capabilities. Some examples of the computing unit 601 include central processing units (CPUs), graphics processing units (GPUs), various dedicated artificial intelligence (AI) computing chips, various computing units running machine learning models and algorithms, digital signal processors (DSPs), and any suitable processors, controllers and microcontrollers. The computing unit 601 executes various preceding methods and processing, such as the multimodal fusion-based high-definition map feature recognition method. For example, in some embodiments, the multimodal fusion-based high-definition map feature recognition method may be implemented as a computer software program tangibly contained in a machine-readable medium such as the storage unit 608. In some embodiments, part or all of computer programs may be loaded and/or installed onto the electronic device 600 via the ROM 602 and/or the communication unit 609. When the computer program is loaded to the RAM 503 and executed by the computing unit 601, one or more operations of the multimodal fusion-based high-definition map feature recognition method may be performed. Alternatively, in other embodiments, the computing unit 601 may be configured, in any other suitable manner (for example, by use of firmware), to execute the multimodal fusion-based high-definition map feature recognition method.

The various embodiments of the systems and techniques described herein may be implemented in digital electronic circuitry, integrated circuitry, a field-programmable gate array (FPGA), an application-specific integrated circuit (ASIC), application specific standard parts (ASSPs), a system on a chip (SoC), a complex programmable logic device (CPLD), computer hardware, firmware, software and/or a combination thereof. Various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input device and at least one output device and transmitting data and instructions to the memory system, the at least one input device and the at least one output device.

Program codes for implementation of the methods of this disclosure may be written in one programming language or any combination of multiple programming languages. These program codes may be provided for the processor or controller of a general-purpose computer, a special-purpose computer, or another programmable multimodal fusion-based high-definition map feature recognition apparatus to cause functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of this disclosure, the machine-readable medium may be a tangible medium that may include or store a program for use by or in connection with an instruction execution system, apparatus, or device. The machine-readable medium may be a machine-readable signal medium or a machine-readable storage medium. The machine-readable medium may include an electronic, magnetic, optical, electromagnetic, infrared, or semiconductor system, apparatus, or device, or any suitable combination thereof. Examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical memory device, a magnetic memory device or any suitable combination thereof.

In order that interaction with a user is provided, the systems and techniques described herein may be implemented on a computer. The computer has a display apparatus for displaying information to the user, such as a cathode-ray tube (CRT) or a liquid-crystal display (LCD) monitor, and a keyboard and a pointing apparatus such as a mouse or a trackball through which the user can provide input to the computer. Other types of apparatuses may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical client interface or a web browser through which a client can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN) and the Internet.

A computer system may include client ends and servers. A client end and a server are generally remote from each other and typically interact through a communication network. The relationship between the client ends and the servers arises by virtue of computer programs running on respective computers and having a client-server relationship to each other. A server may be a cloud server, a server of a distributed system, or a server combined with a blockchain.

Artificial intelligence is a discipline studying the simulation of certain human thinking processes and intelligent behaviors (such as learning, reasoning, thinking, and planning) by a computer and involves techniques at both hardware and software levels. Hardware techniques of artificial intelligence generally include techniques such as sensors, special-purpose artificial intelligence chips, cloud computing, distributed storage, and big data processing. Software techniques of artificial intelligence mainly include several major directions such as computer vision technology, speech recognition technology, natural language processing technology, machine learning/deep learning technology, big data processing technology, and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and blockchain.

Various forms of the preceding flows may be used, with operations reordered, added or removed. For example, the steps described in this disclosure may be executed in parallel, in sequence, or in a different order as long as the desired results of the technical solutions disclosed in this disclosure are achieved. The execution sequence of these operations is not limited herein.

1. A multimodal fusion-based high-definition map feature recognition method, comprising:
determining attribute characteristics of a target map feature, pixel registration characteristics of the target map feature, and hybrid registration characteristics of the target map feature based on at least two types of candidate image data of the target map feature and point cloud data of the target map feature;
determining a pixel correspondence of the target map feature based on the pixel registration characteristics of the target map feature and determining a hybrid correspondence of the target map feature based on the hybrid registration characteristics of the target map feature; and
fusing the attribute characteristics of the target map feature based on the pixel correspondence and the hybrid correspondence to obtain a fused characteristic of the target map feature and determining a feature category of the target map feature based on the fused characteristic of the target map feature.

2. The multimodal fusion-based high-definition map feature recognition method of claim 1, wherein determining the pixel correspondence of the target map feature based on the pixel registration characteristics of the target map feature and determining the hybrid correspondence of the target map feature based on the hybrid registration characteristics of the target map feature comprises:
selecting target image data from the at least two types of candidate image data;
performing registration between the target image data and candidate image data other than the target image data in the at least two types of candidate image data based on the pixel registration characteristics of the target map feature to obtain the pixel correspondence of the target map feature; and
performing registration between the target image data and the point cloud data based on the hybrid registration characteristics of the target map feature to determine the hybrid correspondence of the target map feature.

3. The multimodal fusion-based high-definition map feature recognition method of claim 2, wherein selecting the target image data from the at least two types of candidate image data comprises:
determining registration reference levels of the at least two types of candidate image data based on device calibration parameters associated with the at least two types of candidate image data; and
determining the target image data from the at least two types of candidate image data based on the registration reference levels.

4. The multimodal fusion-based high-definition map feature recognition method of claim 2, wherein performing the registration between the target image data and the candidate image data other than the target image data in the at least two types of candidate image data based on the pixel registration characteristics of the target map feature to obtain the pixel correspondence of the target map feature comprises:
performing, based on the pixel registration characteristics of the target map feature, registration between pixel coordinates of the target map feature in the target image data and pixel coordinates of the target map feature in the candidate image data other than the target image data in the at least two types of candidate image data to obtain the pixel correspondence of the target map feature.

5. The multimodal fusion-based high-definition map feature recognition method of claim 2, wherein performing the registration between the target image data and the point cloud data based on the hybrid registration characteristics of the target map feature to determine the hybrid correspondence of the target map feature comprises:
performing registration between pixel coordinates of the target map feature in the target image data and point cloud coordinates of the target map feature in the point cloud data based on the hybrid registration characteristics of the target map feature to obtain the hybrid correspondence of the target map feature.

6. The multimodal fusion-based high-definition map feature recognition method of claim 1, wherein determining the attribute characteristics of the target map feature, the pixel registration characteristics of the target map feature, and the hybrid registration characteristics of the target map feature based on the at least two types of candidate image data of the target map feature and the point cloud data of the target map feature comprises:
determining a key pixel of the target map feature based on the at least two types of candidate image data; and
determining the pixel registration characteristics of the target map feature based on a pixel characteristic of the key pixel.

7. The multimodal fusion-based high-definition map feature recognition method of claim 1, wherein determining the attribute characteristics of the target map feature, the pixel registration characteristics of the target map feature, and the hybrid registration characteristics of the target map feature based on the at least two types of candidate image data of the target map feature and the point cloud data of the target map feature comprises:
determining device calibration parameters associated with the at least two types of candidate image data; and
determining the hybrid registration characteristics of the target map feature based on the device calibration parameters, pixel coordinates of the target map feature in the at least two types of candidate image data, and point cloud coordinates of the target map feature in the point cloud data.

8. The multimodal fusion-based high-definition map feature recognition method of claim 1, wherein fusing the attribute characteristics of the target map feature based on the pixel correspondence and the hybrid correspondence to obtain the fused characteristic of the target map feature comprises:
determining at least two attribute characteristics of the target map feature from attribute characteristics belonging to the at least two types of candidate image data based on the pixel correspondence;
determining attribute characteristics of the target map feature from attribute characteristics belonging to the point cloud data based on the hybrid correspondence; and
fusing the determined at least two attribute characteristics belonging to the at least two types of candidate image data and the determined attribute characteristics belonging to the point cloud data to obtain the fused characteristic of the target map feature.

9. The multimodal fusion-based high-definition map feature recognition method of claim 1, further comprising:
determining a feature position of the target map feature based on the point cloud data;
associating the feature position with the feature category of the target map feature based on the hybrid correspondence; and
generating a high-definition map based on the feature position and the feature category of the target map feature.

10. The multimodal fusion-based high-definition map feature recognition method of claim 1, wherein the target map feature is a lane marking.

11. The multimodal fusion-based high-definition map feature recognition method of claim 1, wherein the at least two types of candidate image data comprise at least two of fused image data, panoramic image data, and industrial camera image data.

12.-22. (canceled)

23. An electronic device, comprising:
at least one processor; and
a memory communicatively connected to the at least one processor;
wherein the memory stores instructions executable by the at least one processor to enable the at least one processor to perform the following:
determining attribute characteristics of a target map feature, pixel registration characteristics of the target map feature, and hybrid registration characteristics of the target map feature based on at least two types of candidate image data of the target map feature and point cloud data of the target map feature;
determining a pixel correspondence of the target map feature based on the pixel registration characteristics of the target map feature and determining a hybrid correspondence of the target map feature based on the hybrid registration characteristics of the target map feature; and
fusing the attribute characteristics of the target map feature based on the pixel correspondence and the hybrid correspondence to obtain a fused characteristic of the target map feature and determining a feature category of the target map feature based on the fused characteristic of the target map feature.

24. A non-transitory computer-readable storage medium storing computer instructions configured to cause a computer to perform the following:
determining attribute characteristics of a target map feature, pixel registration characteristics of the target map feature, and hybrid registration characteristics of the target map feature based on at least two types of candidate image data of the target map feature and point cloud data of the target map feature;
determining a pixel correspondence of the target map feature based on the pixel registration characteristics of the target map feature and determining a hybrid correspondence of the target map feature based on the hybrid registration characteristics of the target map feature; and
fusing the attribute characteristics of the target map feature based on the pixel correspondence and the hybrid correspondence to obtain a fused characteristic of the target map feature and determining a feature category of the target map feature based on the fused characteristic of the target map feature.

25. (canceled)

26. The electronic device of claim 23, wherein the at least one processor is enabled to perform determining the pixel correspondence of the target map feature based on the pixel registration characteristics of the target map feature and determining the hybrid correspondence of the target map feature based on the hybrid registration characteristics of the target map feature by:
selecting target image data from the at least two types of candidate image data;
performing registration between the target image data and candidate image data other than the target image data in the at least two types of candidate image data based on the pixel registration characteristics of the target map feature to obtain the pixel correspondence of the target map feature; and
performing registration between the target image data and the point cloud data based on the hybrid registration characteristics of the target map feature to determine the hybrid correspondence of the target map feature.

27. The electronic device of claim 26, wherein the at least one processor is enabled to perform selecting the target image data from the at least two types of candidate image data by:
determining registration reference levels of the at least two types of candidate image data based on device calibration parameters associated with the at least two types of candidate image data; and
determining the target image data from the at least two types of candidate image data based on the registration reference levels.

28. The electronic device of claim 26, wherein the at least one processor is enabled to implement performing the registration between the target image data and the candidate image data other than the target image data in the at least two types of candidate image data based on the pixel registration characteristics of the target map feature to obtain the pixel correspondence of the target map feature by:
performing, based on the pixel registration characteristics of the target map feature, registration between pixel coordinates of the target map feature in the target image data and pixel coordinates of the target map feature in the candidate image data other than the target image data in the at least two types of candidate image data to obtain the pixel correspondence of the target map feature.

29. The electronic device of claim 26, wherein the at least one processor is enabled to implement performing the registration between the target image data and the point cloud data based on the hybrid registration characteristics of the target map feature to determine the hybrid correspondence of the target map feature by:
performing registration between pixel coordinates of the target map feature in the target image data and point cloud coordinates of the target map feature in the point cloud data based on the hybrid registration characteristics of the target map feature to obtain the hybrid correspondence of the target map feature.

30. The electronic device of claim 23, wherein the at least one processor is enabled to implement determining the attribute characteristics of the target map feature, the pixel registration characteristics of the target map feature, and the hybrid registration characteristics of the target map feature based on the at least two types of candidate image data of the target map feature and the point cloud data of the target map feature by:
determining a key pixel of the target map feature based on the at least two types of candidate image data; and
determining the pixel registration characteristics of the target map feature based on a pixel characteristic of the key pixel.

31. The electronic device of claim 23, wherein the at least one processor is enabled to implement determining the attribute characteristics of the target map feature, the pixel registration characteristics of the target map feature, and the hybrid registration characteristics of the target map feature based on the at least two types of candidate image data of the target map feature and the point cloud data of the target map feature by:
determining device calibration parameters associated with the at least two types of candidate image data; and
determining the hybrid registration characteristics of the target map feature based on the device calibration parameters, pixel coordinates of the target map feature in the at least two types of candidate image data, and point cloud coordinates of the target map feature in the point cloud data.

32. The electronic device of claim 23, wherein the at least one processor is enabled to implement fusing the attribute characteristics of the target map feature based on the pixel correspondence and the hybrid correspondence to obtain the fused characteristic of the target map feature by:
determining at least two attribute characteristics of the target map feature from attribute characteristics belonging to the at least two types of candidate image data based on the pixel correspondence;
determining attribute characteristics of the target map feature from attribute characteristics belonging to the point cloud data based on the hybrid correspondence; and
fusing the determined at least two attribute characteristics belonging to the at least two types of candidate image data and the determined attribute characteristics belonging to the point cloud data to obtain the fused characteristic of the target map feature.
